(19) United States
(12) Patent Application Publication
(10) Pub. No.: US 2014/0301837 A1
(43) Pub. Date: Oct. 9, 2014

(54) DOOR FOR A THRUST REVERSER WITH DOORS

(71) Applicant: AIRCELLE, GONFREVILLE L'ORCHER (FR)

(72) Inventors: Nicolas DEZEUSTRE, LE HAVRE (FR); Xavier HERT, Magnanville (FR); Luc QUERNET, Montsoult (FR)

(21) Appl. No.: 14/310,184

(22) Filed: Jun. 20, 2014

Related U.S. Application Data
(63) Continuation of application No. PCT/FR2012/052837, filed on Dec. 7, 2012.

(30) Foreign Application Priority Data
Dec. 23, 2011 (FR) 1162356

(51) Int. Cl. F02K 1/56

(52) U.S. Cl. CPC F02K 1/566
USPC 415/208.1; 239/265.19

(57) ABSTRACT

A door for a door-type thrust reverser is pivotally mounted on a stationary structure of a thrust reverser. The door includes an inner surface integrated to a flow path of an air flow generated by a turbojet engine, an outer surface providing an outer aerodynamic continuity of a nacelle equipped with the thrust reverser, a spoiler to deflect the air flow disposed at an upstream end of the door, and an actuator actuating the spoiler. The spoiler is movably mounted, in rotation around a rotation axis substantially perpendicular to a front frame of the door, between a retracted and a deployed position. In particular, the actuator includes a first rod connected to the spoiler, a second rod connected to the first rod and the front frame, and a third rod connected to the first and second rods as well as to the spoiler.

### CROSS-REFERENCE TO RELATED APPLICATIONS

This application is a continuation of International Application No. PCT/FR2012/052837, filed on Dec. 7, 2012, which claims the benefit of FR 11/62356 filed on Dec. 23, 2011. The disclosures of the above applications are incorporated herein by reference.

### FIELD

The present disclosure relates to a door for a door-type thrust reverser as well as such a thrust reverser and a nacelle equipped with such a thrust reverser.

### BACKGROUND

The statements in this section merely provide background information related to the present disclosure and may not constitute prior art.

The role of a thrust reverser during aircraft landing is to improve the braking ability of an aircraft by redirecting to the front at least a part of the thrust generated by the turbojet engine. In this phase, the thrust reverser obstructs the gas ejection nozzle and directs the ejection flow of the engine towards the front of the nacelle, thereby generating a counter-thrust which comes to accompany the braking of the aircraft wheels. The means implemented for achieving this flow redirection vary according to the type of thrust reverser.

The structure of a thrust reverser comprises movable cowls which travel between, on the one hand, a deployed position in which they open in the nacelle a passage intended for the diverted flow, and on the other hand, a stowed position in which they close this passage. These movable cowls may further fulfill a diverting function or simply one of actuating other diverting means.

In the cascade-type thrust reversers, for example, the movable cowls slide along the rails in such a manner that when moving rearward during the opening phase, they uncover the cascade vanes disposed in the thickness of the nacelle. A system of rods connects this movable cowl to blocking doors which are deployed within the ejection channel and block the direct flow outlet.

In door-type thrust reversers, however, each movable cowl swivels in such a manner as to block the flow and divert it and is hence, active in this redirection. More particularly, a door-type thrust reversal device comprises one or several doors pivotally mounted in such a manner as to be able, under the action of driving means, to switch between an inactive position called closing position during operation of the turbojet engine in so-called direct jet mode in which the doors constitute a portion of the downstream section, and a reversal position or opening position in which they switch in such a manner that a downstream portion of each door at least partially obstructs the duct of the nacelle and that an upstream portion opens within the downstream section a passage allowing the air flow to be channeled radially with respect to a longitudinal axis of the nacelle. The swivel angle of the doors is adjusted in such a manner as to highly reduce or even cancel the thrust force generated by the flow exiting in direct jet mode and thus, until possibly generating a counter-thrust by generating a component of the diverted flow upstream of the nacelle.

In order to be able to improve the air flow redirection in a direction approaching as closely as possible to a longitudinal direction of the nacelle, the doors have been equipped with deflecting means, usually constituted by terminal spoilers, also called deflectors, forming upstream of the door a substantially perpendicular return to the latter. Thus, when the door is in thrust reversal position, the spoiler is oriented in a substantially longitudinal direction of the nacelle and forces the air flow in this direction. Reciprocally, when the door is in closing position, each spoiler is directed in a substantially perpendicular direction to the longitudinal axis of the nacelle. Each spoiler thus penetrates into the flow path of the air flow and thus risks blocking the air flow circulating in the nacelle in direct jet mode, which is unacceptable.

In order to overcome this drawback, the doors were designed in such a manner as to exhibit an upstream cavity at an inner surface of said door. Thereby, the door exhibits upstream a reduced thickness which allows the spoiler both to protrude from said door and not have a length greater than the thickness of the nacelle upstream of the door so as not to penetrate in the flow path of the air flow when the door is in closed position. A general structure of thrust reverser door is represented on FIGS. 1 and 2 in respectively closed and open positions. It is however worth noting that such a cavity constitutes an important aerodynamic accident inside the air flow path when the door is in closing position, thus reducing the overall performance of the turbojet engine.

Various solutions have been implemented in order to attempt to reduce the depth of this cavity, and even remove it. It is known in particular, the doors for door-type thrust reversers equipped with retractable spoilers.

Such solutions are for example described in documents U.S. Pat. No. 6,293,495 and EP 0 301 939. However, the systems implemented are still complicated, in particular, as regards the guiding and articulating means, remaining complex and/or fragile.

A solution to these issues has been provided by patent FR 2 916 484 belonging to the applicant, according to which a door for a door-type thrust reverser is equipped with a movable spoiler in rotation in a plane perpendicular to the plane of the door.

A drawback related to this form resides in the reliability of the actuating system of the spoiler of the door, proving to not be solid enough with respect to the efforts made by the spoiler during its opening.

In fact, the deflecting means are subjected to important efforts able to lead to the wrenching out of the deflecting means when the latter are in deployed position, that is to say, for an opening position of the door.

Another drawback of this solution is linked to the geometry of the spoiler. In fact, such a spoiler according to the prior art gets deformed under load and vibrates during usage of the turbojet engine.

These drawbacks cause the degradation of the performance of the thrust reverser in direct jet and reverse jet modes.

### SUMMARY

The present disclosure provides a door for a door-type thrust reverser, of which the deflecting means do not get deformed under load and do not vibrate during low frequency usage of the turbojet engine, and of which the actuating systems of such spoilers are sufficiently solid to resist efforts caused by the spoilers during their opening.

To this end, the present disclosure provides a door for a door-type thrust reverser able to be pivotally mounted on a stationary structure of a thrust reverser comprising:
an inner surface designed to be integrated to a flow path of an air flow generated by a turbojet engine and an outer surface designed to provide the outer aerodynamic continuity of a nacelle intended to be equipped with said thrust reverser,
means for deflecting the air flow disposed at an upstream end of the door and movably mounted, in rotation around an axis substantially perpendicular to a front frame of the door, between a retracted position corresponding to a closing position of the door and a deployed position in which the deflecting means protrude from the door corresponding to an opening position of the door,
means for actuating said deflecting means from one to the other of their retracted and deployed positions,
said door being characterized in that said actuating means comprise:
a first rod connected by means of elastic means to said deflecting means,
a second rod connected, on the one hand, to said first rod, and on the other hand, to said front frame, and
a third rod connected, on the one hand, to the two previous ones, and the other hand, to said deflecting means,
said elastic means being able to open the angle formed by said second and third rods.

The actuating means according to the present disclosure are shaped to resist efforts subjected by the deflecting means during their opening and allow maintaining said deflecting means in a position in which they provide an optimal redirection of the flow crossing the path and blocked by the door. Furthermore, the actuating means according to the present disclosure comprises an assembly of three rods connected to elastic means, thus constituting a relatively easy system to assemble and limited in number of pieces required for the deployment and retraction of the deflecting means, thus allowing to reduce the mass of the assembly constituted by the deflecting means and by the actuating means thereof.

According to a feature of the present disclosure, the deflecting means exhibit at least one surface forming an extension of the inner surface of the door when said door is in opening position.

Advantageously, the elastic means are integrally contained inside the deflecting means when the door is in closing position.

This disposition of the elastic means allows to not overburden the thrust reverser in which the door is intended to be mounted according to the present disclosure.

The elastic means comprise traction spring or compression spring.

According to a feature of the door according to the present disclosure, the first rod is able to come in abutment with an inner centralizer of the compression spring.

According to another feature, the door comprises secondary retaining means comprising at least one stop integral with the deflecting means and shaped to engage in at least one support integral with the front frame of the door.

The rotation axis of the deflecting means is located near a side end of the door.

The present disclosure also relates to a door-type thrust reverser comprising at least one door and one stationary structure on which said door is pivotally mounted between a first position, called closing position, in which it closes the thrust reverser and constitutes a portion of an external cowling, the means for deflecting the flow being in retracted position, and a second position, called opening position, in which it clears a passage in the stationary structure and is able to at least partially block an air flow generated by a turbojet engine, the deflecting means being in deployed position.

According to a feature of the thrust reverser according to the present disclosure, said door-type thrust reverser comprises primary retaining means comprising at least one upper stop integral with the deflecting means and shaped to engage in at least one stop support integral with the front frame of the door, and at least one lower stop shaped to engage in at least one stop support integral with the stationary portion of the thrust reverser.

The retaining means allow blocking of the spoiler during its rotational movement around its rotation axis, corresponding to the passage from a closing position to an opening position of the door.

According to another feature of the present disclosure, the thrust reverser comprises guiding means comprising, on the one hand, a roller integral with the deflecting means and able to travel along a ramp integral with the stationary structure of the thrust reverser and, on the other hand, a guide integral with the deflecting means and able to travel along a profile of the support integral with the front frame of the door.

Finally, the present disclosure also relates to a nacelle for a turbojet engine, said nacelle being characterized in that it is equipped with at least one thrust reverser system according to the present disclosure.

Other features, purposes and advantages of the present disclosure will become apparent upon reading the following detailed description according to the forms given by way of non-limiting examples and with reference to the accompanying drawings on which:

### DRAWINGS

In order that the disclosure may be well understood, there will now be described various forms thereof, given by way of example, reference being made to the accompanying drawings, in which:

FIG. 1 is a cross-sectional view of a door-type thrust reverser according to the prior art, of which the door is in closing position;

FIG. 2 is a view similar to that of FIG. 1, the door being in opening position;

FIG. 3 schematically represents a spoiler according to the prior art;

FIG. 4 represents a first form of a door provided with deflecting means according to the present disclosure, said means being in retracted position;

FIG. 5 represents the deflecting means in deployed position;

FIG. 6 illustrates, as on FIG. 4, a second form of the door according to the present disclosure;

FIG. 7 is a cross-sectional view of the compression spring of the actuating means;

FIG. 8 represents the deflecting means in deployed position, according to the second form of the present disclosure;

FIG. 9 is centered on the retaining and guiding means of the deflecting means, said means being in deployed position;

FIG. 10 represents the guiding of the deflecting means on the stationary portion of the thrust reverser;

FIG. 11 illustrates the lower stop of the deflecting means penetrating in a stop support of the stationary structure of the thrust reverser;

FIG. 12 is an isometric view of the deflecting means;

FIG. 13 illustrates the curved surface of the deflecting means in deployed position.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Furthermore, the words “upstream” and “downstream” are defined with reference to the flow direction of the air flow in the nacelle in direct jet mode, the upstream of the nacelle corresponding to a portion of the nacelle by which the flow penetrates, and the downstream corresponding to an area for ejecting said air flow.

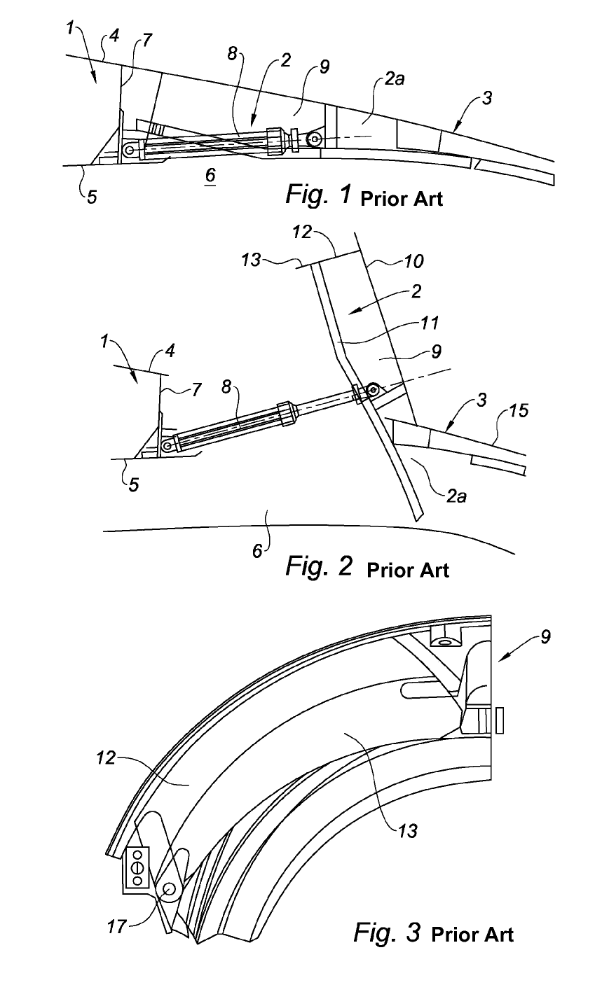

FIG. 1 illustrates a known example of form of a door-type thrust reverser equipped with a deflection spoiler.

A thrust reverser of this type comprises three main portions, namely a stationary portion 1, located upstream in the extension of an outer wall of an air flow channel of the turbojet engine, a movable portion 2 and a rear stationary ferrule 3.

The stationary portion 1 comprises an outer panel 4 of the nacelle and an inner panel 5 constituting an outer panel of a flow path 6 of the air flow.

The outer 4 and inner 5 panels of the stationary portion 1 are connected by a front frame 7 which also provides the support of the means for controlling the movable portion 2, constituted in this instance by a jack 8. The movable portion 2 is decomposed into one or several commonly movable members called doors 9.

Each door 9 is pivotally mounted in such a manner as to be able, under the action of the control means 8, to switch between a position in which it provides the structural continuity between the stationary portion 1 and the rear portion 3 as well as the inside of the path 6 and an opening position in which it clears a passage between the stationary portion 1 and the rear portion 3 allowing a release of the air flow by said opening.

As represented on FIG. 2, during this swiveling, a rear portion of the door 2a at least partially blocks the path 6 thus forcing the flow to circulate through the cleared opening. From a structural point of view, the door 9 comprises, on the one hand, an outer panel 10 which, in direct jet mode, is placed in the extension of the outer panel 4 of the stationary portion and provides an external aerodynamic continuity with an outer panel 15 of the rear portion 3, and on the other hand, an inner panel 11 and a front frame 12 of the door 9, constituting an upstream end of the door, connecting the outer panel 10 and the inner panel 11. The front frame 12 is extended by deflecting means 13 intended, when the door 9 is open, to redirect part of the air flow towards the front of the nacelle thereby generating a counter-thrust.

The deflecting means are, according to the prior art, stationary or movable. With reference to FIG. 3, illustrating a form of the present disclosure defined in patent FR 2 916 484, the deflecting means 13 are movable in rotation around a rotation axis 17 substantially perpendicular to the front frame 12 of the door 9, and located near a side end of the door. The deflecting means 13 are in a deployed position and protrude from the door 9, a position corresponding to an opening position of the door for an operation of the nacelle in reverse jet mode.

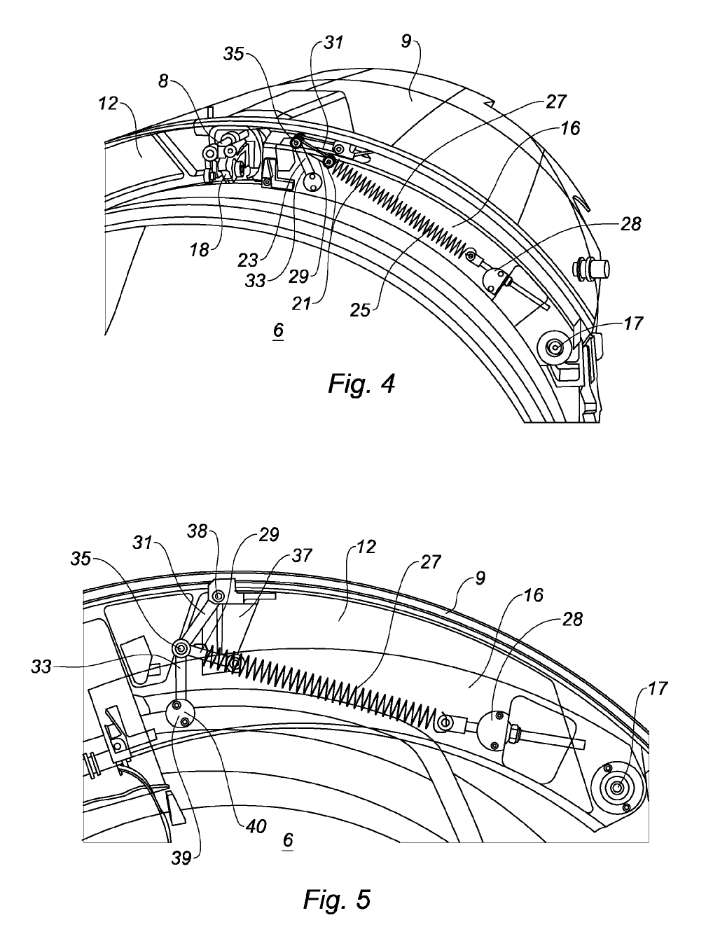

According to the present disclosure, and as illustrated in FIGS. 4 to 13, the deflecting means 13 are replaced by the reflecting means 16. It may consist, of for example spoilers or flaps, of which the geometry is detailed further hereinafter.

FIG. 4 illustrates the door 9 according to the present disclosure in a position called closing position, a position according to which the nacelle operates in direct jet mode and the deflecting means are retracted.

According to this configuration, it is to be noted that the deflecting means do not penetrate into the flow path 6 when the door is closed, thus preventing the disruption of the air flow circulation.

The door 9 is able to be opened by activating the control means 8. These control means may be constituted for example by a jack of which one end is connected to the stationary structure of the thrust reverser.

The actuation of the control means of the door leads to the opening of the door 9, and in addition the deployment of the deflecting means 16.

In fact, according to the present disclosure, the deflecting means 16 are able to be actuated during opening the door 9 by means of actuating means 21 comprising an assembly of rods 23 and elastic means.

According to a first form of the present disclosure, such as the one represented on FIG. 4, the elastic means 25 are constituted by a traction spring 27.

The traction spring 27 is integrally contained inside the spoiler 16 when the latter is in retracted position, in order not to overburden the thrust reverser.

The spring 27 is connected by one of its ends to the assembly of rods 23 and by the other of its ends to an axis 28 integral with the spoiler 16.

The side ends of the spring 27 adopt a substantially loop shape penetrating into the orifices of the assembly of rods 23 and the axis 28. These loops prevent the spring from escaping in the case of vibrations.

The assembly of rods 23 comprises a first rod 29, a second rod 31 and a third rod 33 being made integral in one of their ends by an axis 35.

The rods are movable in rotation around said axis 35, intersection axis of the rods, substantially parallel with the rotation axis 17 of the spoiler 16. The rotation axis 17 is located near a side end of the door 9, but may also be located near the median axis 18 of the door 9.

When the door is in closing position, the angle formed by the second rod and the first rod, and the angle formed by the third rod and the first rod are relatively low, more particularly, usually lower than 45°.

It is now referred to FIG. 5, illustrating the spoiler 16 in deployed position.

The first rod 29 is connected in one of its ends to the two other rods 31 and 33 and in the other of its ends to the traction spring 27, connected to the spoiler 16 by means of the axis 28.

The second rod 31 is connected in one of its ends to the two other rods 29 and 33 and in the other of its ends to the front frame 12 of the door 9. The connection between said second rod and said front frame 12 is achieved by means of a support 37 integral with the front frame of the door.

The second rod 31 is movable in rotation around an axis 38 of the support 37, said axis being substantially parallel with the rotation axis 17 of the spoiler 16.

The third rod 33 is connected in one of its ends to the two other rods 29 and 31 and in the other of its ends to the movable spoiler 16. The connection between said third rod and said movable spoiler 16 is achieved by means of a support 39 integral with the movable spoiler.

The third rod 33 is movable in rotation around an axis 40 of the support 39, said axis being substantially parallel to the rotation axis 17 of the spoiler 16.

The operation of the control system according to the present disclosure is described herein below, still with reference to FIG. 5.

In the closing position of the door 9, (represented FIG. 4, the deflecting means 16 are retracted and bear against the stationary structure of the thrust reverser.

The actuation of the control means 8 of the door 9 allows the swiveling of said door and the opening of the latter.

During such an operation of the opening of the door, the deflecting means 16 no longer bear against the stationary surface of the thrust reverser, and the elastic means, connected to the second rod 29 tend to draw it, thus, causing a displacement of the intersection axis 35 of the rods in a direction such that the angle between the rod 31 and the rod 29, and the angle between the rod 33 and the rod 29 are substantially increased with respect to said angles formed when the door was in closing position, thus allowing the deployment of the deflecting means, then the maintaining in this deployed position when the door is completely open.

More particularly, said angles are usually higher than or equal to 70° when the door is in opening position.

The deflecting means 16 thus protrude from the door 9, thus allowing improving the orientation of the air flow upstream of the nacelle.

These actuating means provide a good hold of the deflecting means when the latter are subjected to important efforts, due to the air flow redirected by the door during its opening.

During a closing operation of the door 9, the deflecting means bear against the protruding stationary surface of the thrust reverser, thus allowing to make the deflecting means 16 swivel into a position in which they are retracted.

In such a position, the deflecting means 16 do not penetrate into the path 6, and hence, do not hinder as a result, the circulation of the air flow in said path when the door is in closing position.

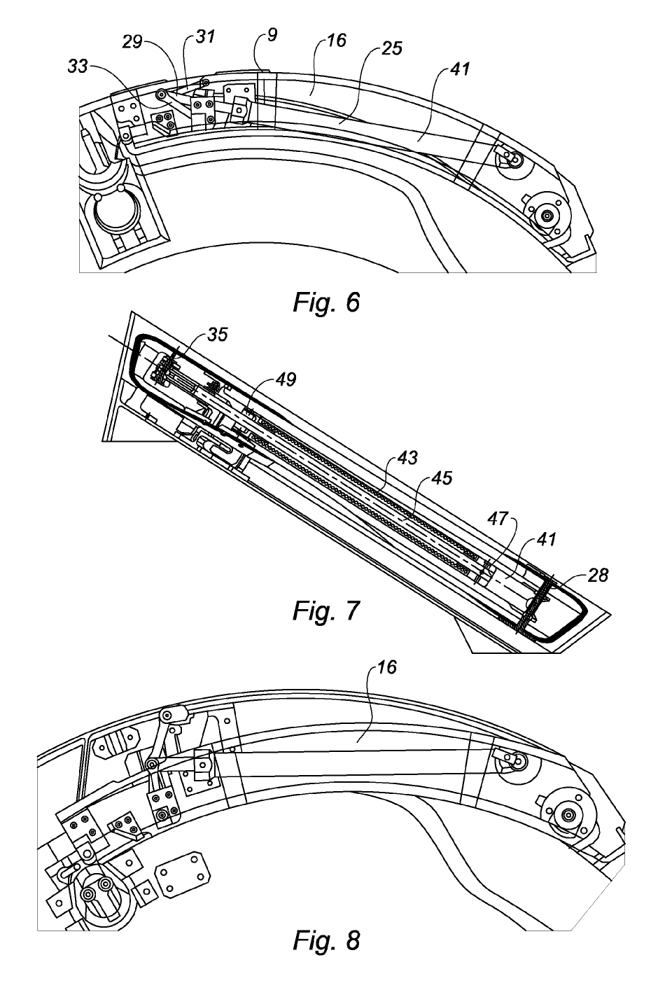

It is now referred to FIG. 6, illustrating a second form of the door according to the present disclosure.

This form is identical to the first form, with the exception that the elastic means 25 are constituted by a compression spring mounted in a tube 41 and not by a traction spring.

FIG. 6 illustrates the deflecting means 16 in retracted position, corresponding to a closing position of the door 9, for which the actuating means are constituted by a compression spring mounted in a tube 41, and by the rods 29, 31, 33.

As illustrated on FIG. 7, the compression spring 43 is wound around an inner tube 45 integral in one of its ends to the assembly of rods. The compression spring and said inner tube are then mounted in the outer tube 41 integral in one of its ends to the axis 28 integral with the spoiler.

The outer tube 41 comprises inside a wall 47 integral with the inner tube 45 against which the spring 43 bears during opening of the door, thus allowing to achieve the traction function of the intersection axis 35 of the rods, such as to allow the increase of the angles between the second and first rods and between the third and first rod, and as a result the deployment of the deflecting means.

The outer tube 41 is provided with an inner centralizer 49 of the compression spring 43.

Furthermore, as for the traction spring, the compression spring 43 is integrally contained in the spoiler when the door is in closing position, such as not to overburden the thrust reverser.

FIG. 8 illustrates, in the manner of FIG. 5, the deflecting means 16 in deployed position, the elastic means being constituted by the compression spring, of which the arrangement has just been described.

The deployment of the deflecting means 16 is achieved in a manner that is similar to what has been previously described when the elastic means were constituted by the traction spring.

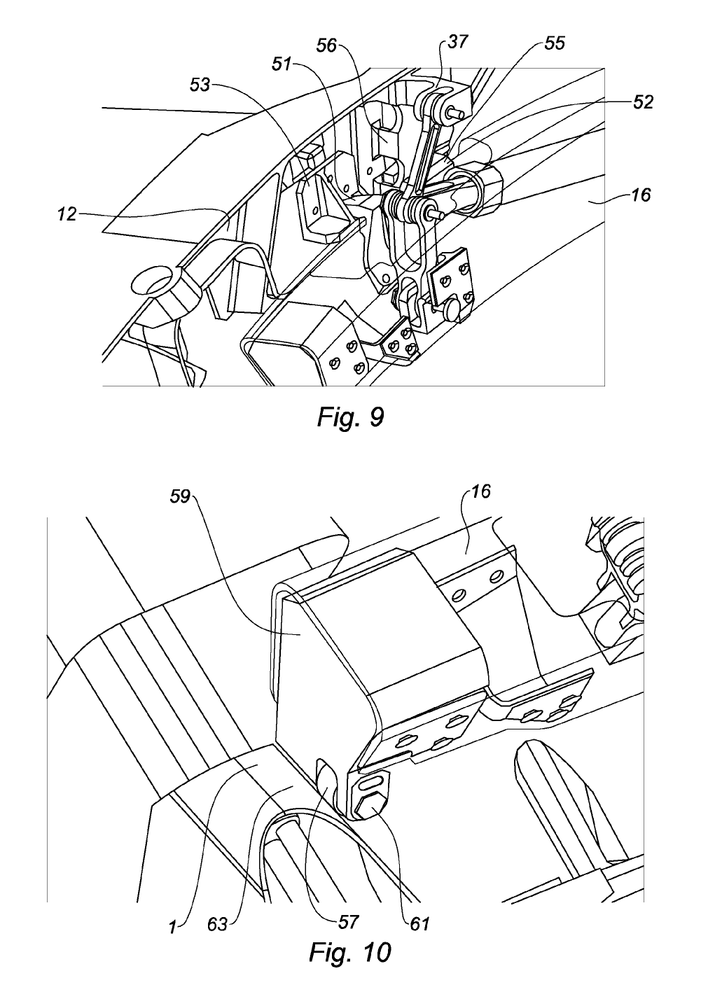

It is now referred to FIG. 9, representing the spoiler 16 in deployed position.

According to the present disclosure, the thrust reverser comprises means for retaining the spoiler 16, said retaining means allowing to block said spoiler during its rotational movement around its axis, corresponding to the passage from a closing position to an opening position of the door.

The spoiler 16 comprises to this end retaining means referred to as primary comprising an upper stop 51 integral with the spoiler 16. The upper stop is engaged in a stop support 53 integral with the front frame 12 of the door so as to allow blocking of the spoiler during the rotation movement of said spoiler.

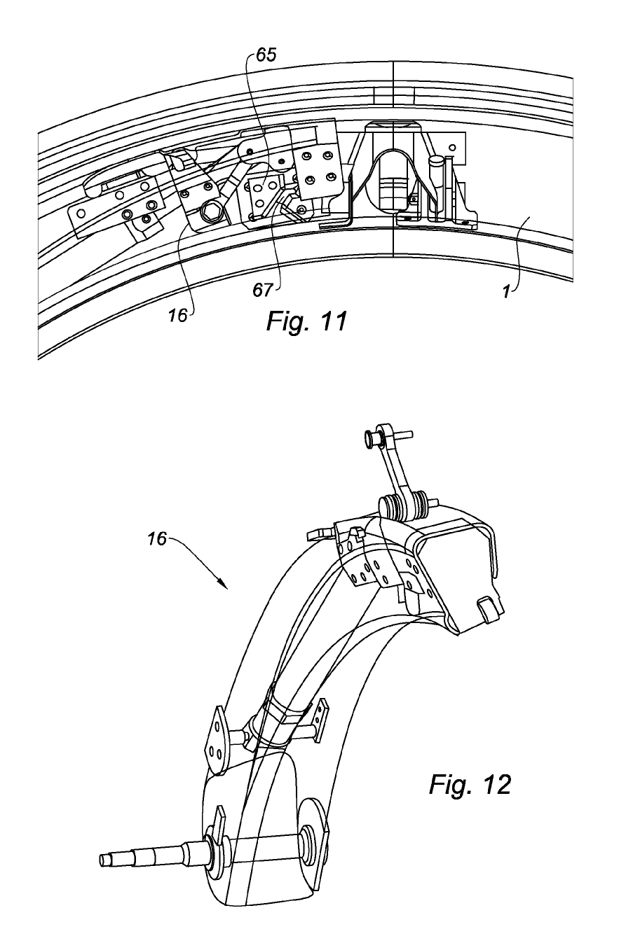

The primary retaining means further comprise a lower stop 65 (visible on FIG. 11), also integral with the spoiler 16, and engaging in a stop support 67 integral with the stationary structure 1 of the thrust reverser.

In addition, by referring to FIG. 9, the spoiler 16 comprises retaining means referred to as secondary, said means comprising a stop 52 integral with the spoiler 16 and engaging in the support 37 integral with the front frame 12 of the door. The secondary retaining means allow, when the primary retaining means are not operational, for example after a rupture of the upper or lower stop, to provide blocking of the spoiler 16 during its rotational movement around its axis.

In order to secure the spoiler 16 in the event of rupture of the primary and secondary retaining means, said spoiler comprises retaining means referred to as tertiary.

The tertiary retaining means of the spoiler 16 is achieved when the end of the first rod comes in contact with the inner centralizer of the compression spring.

In order to guide the spoiler 16 during its rotational movement, alternatively between a retracted position and a deployed position, said spoiler is provided with guiding means.

Such guiding means are constituted by a guide 55 and the support 37 integral with the front frame of the door.

The support 37 is in fact arranged so that the guide 55 moves along a profile 56 of the support 37 when the spoiler 16 is in rotational movement around its rotation axis.

With reference to FIG. 10, the guiding means also comprise an assembly constituted by a roller 57 integral with the spoiler 16 and located on a peripheral wall 59 of said spoiler, of which the rotation axis 61 substantially passes by the median axis of the door.

The roller 57 is intended to come in contact with a ramp 63 integral with the stationary portion 1 of the thrust reverser.

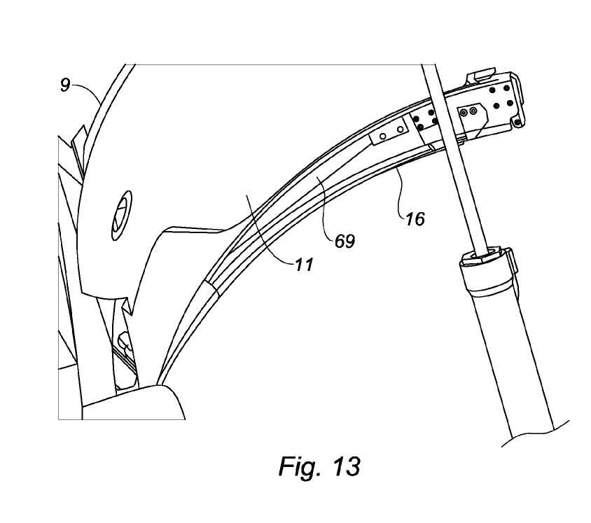

It is now referred to FIG. 12, illustrating in an isometric view the spoiler 16 according to the present disclosure.

According to the present disclosure, the spoiler 16 adopts a substantially curved parallelepiped shape, and it can be achieved in carbon.

With reference to FIG. 13, said spoiler 16 comprises a curved inner surface 69 and shaped to achieve an extension of the inner surface 11 of the door 9 substantially parallel with the motor axis when said door is in open position and the spoiler 16 is deployed.

This geometry allows improving the aerodynamic operation of the spoiler.

It is worth noting that the set of figures each exhibits a door equipped with a movable spoiler according to the present disclosure. The door may obviously be equipped with a plurality of spoilers, and in particular two spoilers. The skilled person will complete by symmetry.

Thanks to the present disclosure, one is able to achieve a movable spoiler for a thrust reverser door of which the actuating means meet the requirements of functionality, reliability and mass and allow the spoiler to resist to stresses undergone during their opening.

Furthermore, the actuating means according to the present disclosure comprise a relatively low number of pieces, thus allowing to facilitate the mounting and reduce the mass of the door with respect to the prior art.

As it goes without saying, the present disclosure is not only limited to the forms of this door, thrust reverser and nacelle integrating said thrust reverser, described above by way of examples, but encompasses all alternatives.

What is claimed is:

1. A door for a door-type thrust reverser pivotally mounted on a stationary structure of a thrust reverser comprising:
an inner surface integrated to a flow path of an air flow generated by a turbojet engine, and an outer surface providing an outer aerodynamic continuity of a nacelle equipped with said thrust reverser;
deflecting means to deflect the air flow disposed at an upstream end of the door and movably mounted, in rotation around a rotation axis substantially perpendicular to a front frame of the door, between a retracted position in which said deflecting means are retracted and a deployed position in which the deflecting means protrude from the door;
means for actuating said deflecting means from the retracted to the deployed positions and vice versa, said actuating means comprising:
a first rod connected by means of elastic means to said deflecting means;
a second rod connected to said first rod and said front frame;and
a third rod connected to the first and second rods, and also to said deflecting means, said elastic means being configured to adjust an angle formed by said second and third rods.

2. The door according to claim 1, wherein the deflecting means exhibit at least one surface forming an extension of the inner surface of the door when said door is in an opening position corresponding to the deployed position.

3. The door according to claim 1, wherein the elastic means are integrally contained inside the deflecting means when the door is in a closing position corresponding to the retracted position.

4. The door according to claim 1, wherein the elastic means comprise a traction spring or a compression spring.

5. The door according to claim 4, wherein the first rod abuts against an inner centralizer of the compression spring.

6. The door according to claim 1, further comprising secondary retaining means comprising at least one stop integral with the deflecting means and shaped to engage in at least one support integral with the front frame of the door.

7. The door according to claim 1, wherein the rotation axis of the deflecting means is located near a side end of the door.

8. The door according to claim 1, wherein said second and third rods is made integral in one of ends thereof by an intersection axis around which said second and third rods rotate.

9. The door according to claim 1, wherein said elastic means comprises a compression spring mounted in an outer tube, the outer tube comprising inside a wall integral with an inner tube against which said compression spring bears during opening the door.

10. A door-type thrust reverser comprising:
at least one door according to claim 1 and the stationary structure on which said door is pivotally mounted between a closing position in which said door closes the thrust reverser and constitutes a portion of an external cowling, said deflecting means being in the retracted position, and an opening position in which said door clears a passage in the stationary structure and is able to at least partially block the air flow, the deflecting means being in the deployed position.

11. The door-type thrust reverser according to claim 10, further comprising primary retaining means which comprise at least one upper stop integral with the deflecting means and shaped to engage in at least one stop support integral with the front frame of the door, and at least one lower stop shaped to engage in at least one stop support integral with the stationary portion of the thrust reverser.

12. The door-type thrust reverser according to claim 10, further comprising guiding means which comprise a roller integral with the deflecting means and traveling along a ramp integral with the stationary structure of the thrust reverser, and a guide integral with the deflecting means and traveling along a profile of a support integral with the front frame of the door.

13. A nacelle for turbojet engine equipped with at least one door-type thrust reverser according to claim 10.
